(19) United States
(12) Patent Application Publication
(10) Pub. No.: US 2005/0161013 A1
(43) Pub. Date: Jul. 28, 2005

(54) Efficient internal combustion engine operation using intake manifold tuning

(76) Inventor: Craig D. Marriott, Clawson, MI (US)

Correspondence Address: CHRISTOPHER DEVRIES;General Motors Corporation, Mail Code 482-C23-B21, P.O. Box 300, Detroit, MI, 48265-3000, US

(21) Appl. No.: 10/763,518

(22) Filed: Jan. 23, 2004

(51) Int. Cl. F02B 27/02

(52) U.S. Cl. 123/184.53

(57) ABSTRACT

An engine control system that controls operation of an internal combustion engine includes an intake manifold that is adjustable to a plurality of resonance geometric configurations. A controller monitors engine operation and classifies engine operation in one of a plurality of operational categories. The controller adjusts the intake manifold to a resonance geometric configuration associated with the operational category.

### FIELD OF THE INVENTION

The present invention relates to internal combustion engines, and more particularly to managing air flow properties through an intake manifold of an internal combustion engine.

### BACKGROUND OF THE INVENTION

Engine systems include an engine having an air intake manifold. Air flows into the intake manifold through an inlet. An air filter removes dirt or debris from the inlet air. A throttle regulates the air flow into the intake manifold. A controller determines an appropriate air/fuel (A/F) ratio for engine operation based on the air flow and other engine parameters.

Internal combustion engines having one or more cylinders may be provided with at least one tuning valve. The tuning valve opens and closes an acoustic through-bore or other acoustic wave communication passages between otherwise differentiated portions of the intake manifold. The tuning valve enables the intake manifold to be adjusted to at least two discrete acoustic resonance geometry configurations (i.e., tuned and detuned).

In one case, the inlet manifold has two intake manifold portions or plenums. The tuning valve is actuated between an open position and a closed position to selectively inhibit air flow between the plenums. More specifically, when the tuning valve is in the open position, the plenums of the intake manifold are in acoustical wave communication. When the tuning valve is in the closed position, the plenums are separated and acoustical wave communication is inhibited. The intake manifold is therefore adjustable to two different acoustic resonance geometry configurations. A degree of freedom is thereby provided to handle certain aspects of the fluid flow within the intake manifold.

Fluid flow of air in the intake manifold of an internal combustion engine is subject to wave impulses. The wave impulses occur as cylinder inlet valves between the cylinders and the intake manifold open and close. The wave impulses also occur as the pistons move in response to crankshaft rotation and either expand or compress the fluid within the cylinders. In an internal combustion engine, positive work is output from the cylinder during the combustion phase. Negative work is used to move the cylinder through the compression, the exhaust and intake portions of the combustion cycle.

### SUMMARY OF THE INVENTION

Accordingly, the present invention provides an engine control system that controls operation of an internal combustion engine. The engine control system includes an intake manifold that is adjustable to a plurality of resonance geometric configurations. A controller monitors engine operation and classifies engine operation in one of a plurality of operational categories. The controller adjusts the intake manifold to a resonance geometric configuration associated with the operational category.

In one feature, the resonance geometric configurations include a tuned configuration and a detuned configuration.

In another feature, each of said operational categories is based on an engine load.

In another feature, the engine control system further includes a throttle input that generates a load command. The controller determines whether an engine load is one of a partial load and a full load based on the load command. The controller adjusts the intake manifold to a first resonance geometric configuration if the engine load is the partial load and adjusts the intake manifold to a second resonance geometric configuration if the engine load is the full load.

In another feature, each of the operational categories is further based on an engine speed.

In still another feature, the engine control system further includes an engine speed sensor that measures the engine speed. The controller compares the engine speed to a threshold engine speed to determine whether the engine speed is one of a high engine speed and a low engine speed. The threshold engine speed is an engine speed at which a volumetric efficiency of the engine is constant regardless of the tuning valve position or intake manifold geometry. The controller adjusts the intake manifold to a first resonance geometric configuration if the engine load is a partial load and the engine speed is less than the threshold engine speed. The controller adjusts the intake manifold to a second resonance geometric configuration if the engine load is the partial load and the engine speed is greater than the threshold engine speed. The controller adjusts the intake manifold to the first resonance geometric configuration if the engine load is a full load and the engine speed is greater than the threshold engine speed. The controller adjusts the intake manifold to the second resonance geometric configuration if the engine load is said full load and the engine speed is less than the threshold engine speed.

In yet another feature, the engine control system further includes a tuning valve that is movable between an open position to provide a first resonance geometric configuration and a closed position to divide the intake manifold into multiple plenums and to provide a second resonance geometric configuration. An actuator manipulates the tuning valve based on a signal from the controller.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of an engine with an active inlet manifold (AIM) having a tuning valve in an open position;

FIG. 2 is a schematic illustration of the engine of FIG. 1 with the tuning valve in a closed position;

FIG. 3 is a graph illustrating cylinder pressure versus crank angle data for a cylinder cycle of the engine operating with the AIM in a tuned state;

FIG. 4 is a graph illustrating cylinder pressure versus crank angle data for a cylinder cycle of the engine operating with the AIM in a detuned state;

FIG. 5 is a graph illustrating a preferred determination of a speed category threshold value for a two-speed-categorized engine; and

FIG. 6 is a flowchart illustrating an exemplary engine control according to the present invention.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements.

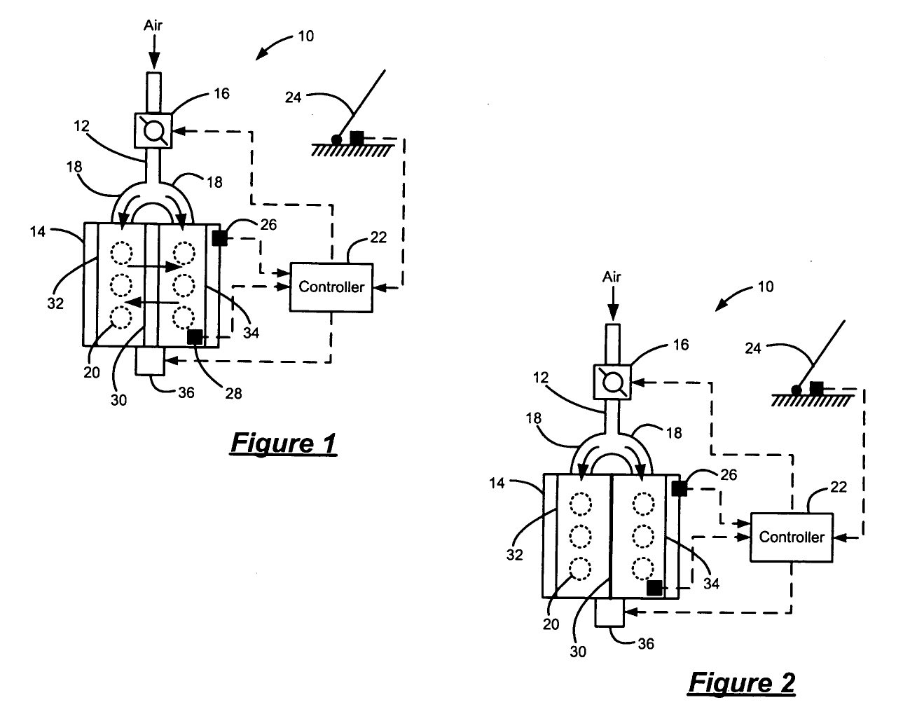

Referring now to FIGS. 1 and 2, an internal combustion engine (ICE) 10 includes an inlet 12 and an intake manifold 14. Air is drawn into the inlet 12 through a throttle 16. The air flows into the intake manifold 14 through split zip tubes 18 of the inlet 12. Air and fuel are drawn into cylinders 20 of the engine 10 through respective inlet valves (not shown). The air/fuel mixture is combusted within the cylinders 20 to drive pistons (not shown). The pistons rotatably drive a crank (not shown) that delivers drive torque to a vehicle driveline (not shown).

A controller 22 controls operation of the engine based on the engine control of the present invention. A commanded load input 24, such as an accelerator pedal, generates a load command signal that is communicated to the controller 22. The controller 22 regulates air flow into the intake manifold 14 based on the load command. An engine speed sensor 26 generates an engine speed signal that is communicated to the controller 22. A manifold absolute pressure (MAP) sensor 28 generates a MAP signal that is communicated to the controller 22. The controller 22 controls engine operation based on the engine speed and MAP signals, as described in further detail below.

The intake manifold 14 is a multi-plenum, active intake manifold (AIM). The intake manifold 14 can be of a discrete position type or of a continuously variable type. Discrete position type intake manifolds include multi-plenums divided by a tuning valve or short/long runner designs with shut-off valves. Continuously variable type intake manifolds include variable runner length designs. Although FIGS. 1 and 2 illustrate a discrete position type intake manifold, it is anticipated that the engine control of the present invention can also be implemented in a continuously variable type AIM. A resonance geometric configuration of the intake manifold 14 is adjusted based on operational categories of the engine 10, as discussed in further detail below. The resonance geometric configurations include a tuned configuration and a detuned configuration.

An intake manifold tuning valve 30 selectively divides the intake manifold into first and second plenums 32, 34. An actuator 36 selectively rotates the tuning valve 30 between an open and a closed position. In the open position, fluid communication is enabled across the entire intake manifold 14. In the closed position, the intake manifold 14 is split into the first and second plenums 32, 34 and fluid communication is inhibited between the first and second plenums 32, 34.

The intake manifold 14 is selectively operated in a tuned state or a detuned state. More specifically, when the tuning valve 30 is in the open position, the intake manifold 14 is in the detuned state. When the tuning valve 30 is in the closed position, the intake manifold 14 is in the tuned state. In the tuned state, the volumetric efficiency (V_{EFF}) is higher than that of the detuned state for the same MAP. As a result, more air and fuel are added and retained in the cylinder 20 in the tuned state than in the detuned state. Therefore, intake manifold tuning is an effective means to improve the power density of the engine 10 at full load conditions.

At equivalent partial load conditions, a higher MAP and a reduced pumping MEP are required in the detuned state than in the tuned state to provide the same cylinder pressure and temperature at inlet valve closure (IVC). IVC is the point at which the cylinder inlet valve is closed and additional air is prohibited from being drawn into or out of the cylinder 20. As a result, more work is performed on the piston during an intake stroke in the detuned state than an intake stroke in the tuned state for an equivalent engine load. Therefore, the total pumping mean effective pressure (PMEP) and brake specific fuel consumption (BSFC) are reduced. More specifically, in the detuned state, BSFC can be improved.

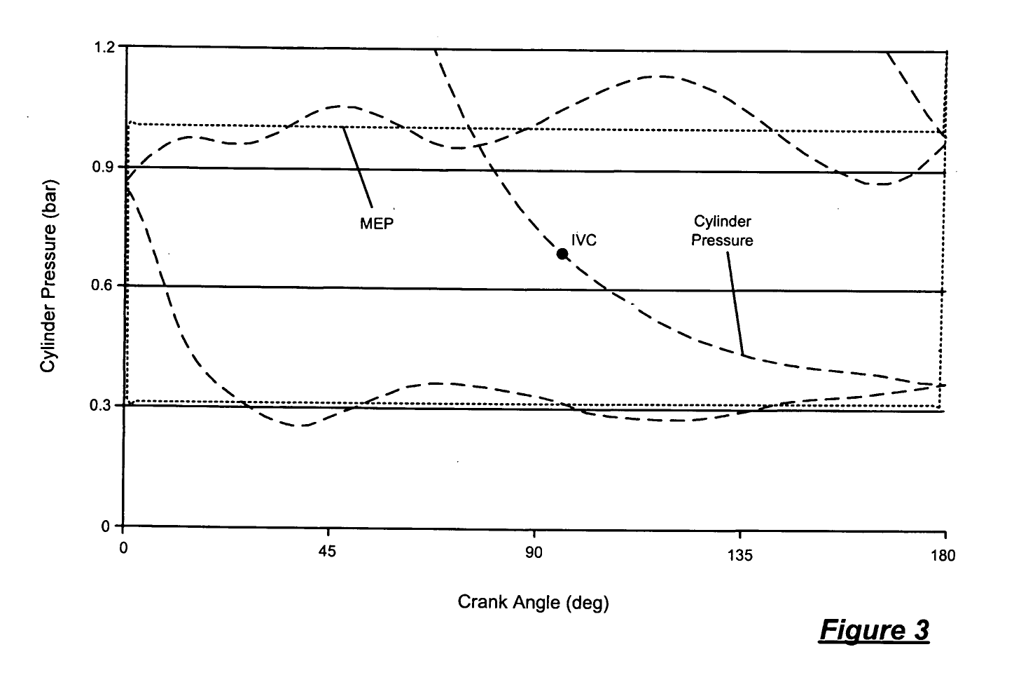

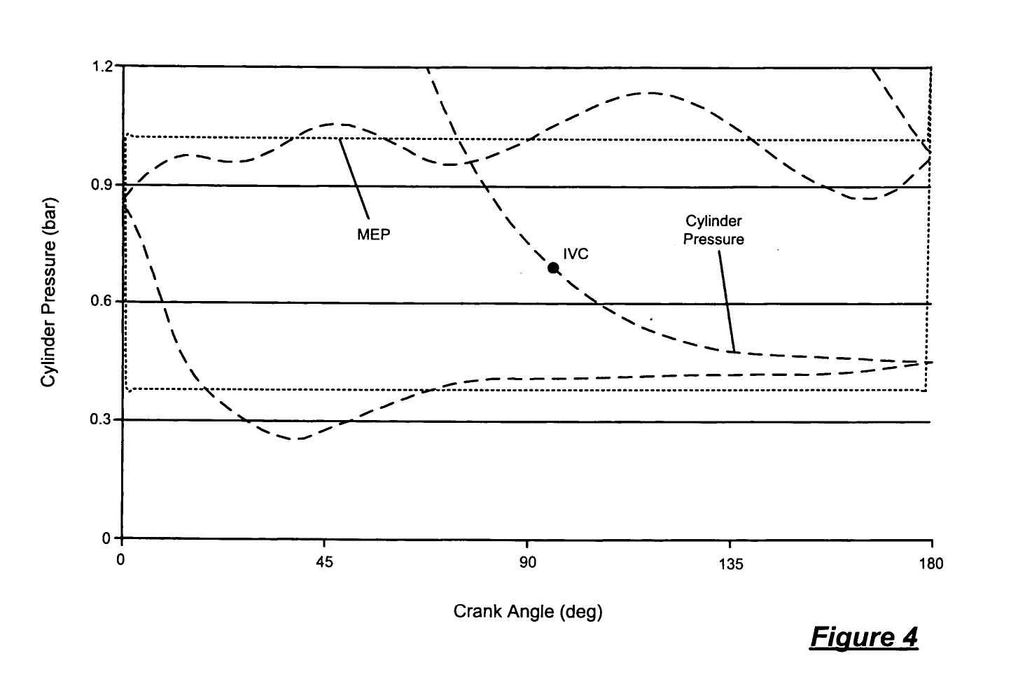

Referring now to FIGS. 3 and 4, the MEP for a cylinder of an exemplary engine operating at a target engine speed is illustrated for the tuned state and the detuned state, respectively. The MEP trace defines a boxed area that represents negative work for the pumping loop portion of the cylinder cycle. The difference in negative work between the tuned state and the detuned state is shown by comparing the bottom boundary of the box of FIG. 3 to that of the of FIG. 4. The detuned state of FIG. 4 produces less negative work in the pumping loop than the tuned state of FIG. 3. As a result, more positive work is available for the same amount of fuel energy. Similarly, less fuel would be required for the same amount of engine output.

The controller 22 determines an operational category of the engine 10 and adjusts the tuning configuration (i.e., tuned state versus detuned state) of the engine 10 based on operational category. The engine control determines the operational category based on comparing an engine load to a maximum engine load value. Alternatively, the operational category can be determined based on comparing the engine speed to a threshold engine speed value and comparing an engine load to a maximum engine load value. This method of determining the operational category is generally implemented when the V_{EFF} cross-over (i.e., the point at where V_{EFF} is equal for the tuned and detuned states) is within the engine operating range.

The engine control operates the engine 10 based on two operational categories, full load and partial load. The engine control determines whether the engine 10 is operating at full load or partial load based on the load command. More specifically, if the load command is less than a predetermined percent of a maximum value, the engine load is deemed partial. If the load command is greater than or equal to the predetermined percent of the maximum value, the engine load is deemed full. In an exemplary embodiment, the predetermined percent is 94%, although it is appreciated that other values may be used.

If the engine 10 is at full load, the controller 22 signals the actuator 36 to manipulate the intake manifold geometry to the tuned state. In the tuned state, the intake manifold 14 is operating to improve the engine output. If the engine 10 is at partial load, the controller 22 signals the actuator 36 to manipulate the intake manifold geometry to the detuned state. In the detuned state, the volumetric efficiency of the engine 10 is decreased as a result of destructively adding the isentropic wave action within the intake manifold 14. In this manner, less throttling is required to produce the same engine load and the associated pumping losses are reduced to provide improved fuel economy.

Alternatively, the engine control can operate the engine based on four operational categories. A first operational category includes low engine speed and partial load. A second operational category includes low engine speed and full load. A third operational category includes high engine speed and partial load and a fourth operational category includes high engine speed and full load. The engine load is determined based on the load command, as discussed in detail above.

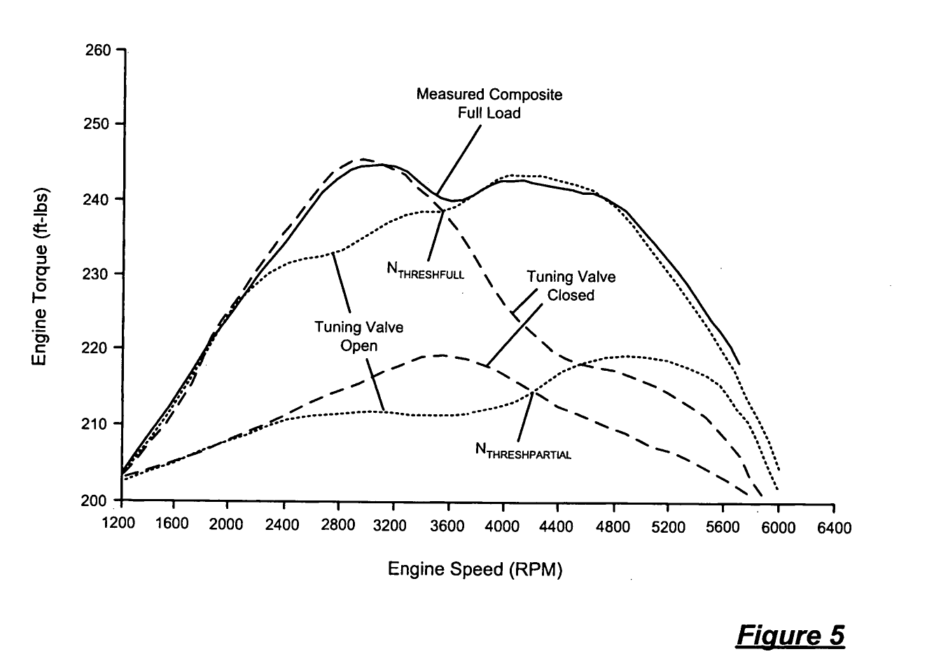

Referring now to FIG. 5, the manner in which a high or low engine speed is determined will be described in detail. FIG. 5 illustrates torque traces for an exemplary engine. The volumetric efficiency of the engine is closely related to the engine torque. A first threshold engine speed (N_{THRESHFULL}) is identified and is the engine speed at which the volumetric efficiency with the tuning valve in the open position (V_{EFFOPEN}) is equivalent to the volumetric efficiency with the tuning valve in the closed position (V_{EFFCLOSED}), under full load. A first threshold engine speed (N_{THRESHPARTIAL}) is identified and is the engine speed at which V_{EFFOPEN} is equivalent to the V_{EFFCLOSED}, under partial load. N_{THRESHFULL} is approximately 3500 RPM and N_{THRESHPARTIAL} is approximately 4200 RPM for the exemplary torque traces. It is appreciated, however, that the threshold engine speeds can vary from engine to engine.

High and low engine speeds (N_{HIGH} and N_{LOW}, respectively) are determined based on N_{THRESH} and a measured engine speed (N_{MEAS}) that is monitored by the engine speed sensor 26. More particularly, if N_{MEAS} is greater than or equal to N_{THRESH}, at full load, the engine speed is consider high (N_{HIGH}). If N_{MEAS} is less than N_{THRESH}, at full load, the engine speed is consider low (N_{LOW}).

When the engine 10 is operating under partial load conditions, the tuning valve position that provides a lower volumetric efficiency is preferred. Therefore, for the exemplary engine characteristics of FIG. 5, the tuning valve 30 is preferably in the open position (i.e., detuned state) when the engine 10 is operating under partial load and N_{LOW} (i.e., the first operational category). Inversely, the tuning valve 30 is preferably in the closed position (i.e., tuned) when the engine 10 is operating under partial load and N_{HIGH} (i.e., the third operational category).

When the engine 10 is operating under full load conditions, the tuning valve position that provides a higher volumetric efficiency is preferred. Therefore, for the exemplary engine characteristics of FIG. 5, the tuning valve 30 is preferably in the open position (i.e., detuned state) when the engine 10 is operating under full load and N_{HIGH} (i.e., the fourth operational category). Inversely, the tuning valve 30 is preferably in the closed position (i.e., tuned) when the engine 10 is operating under partial load and N_{LOW} (i.e., the second operational category).

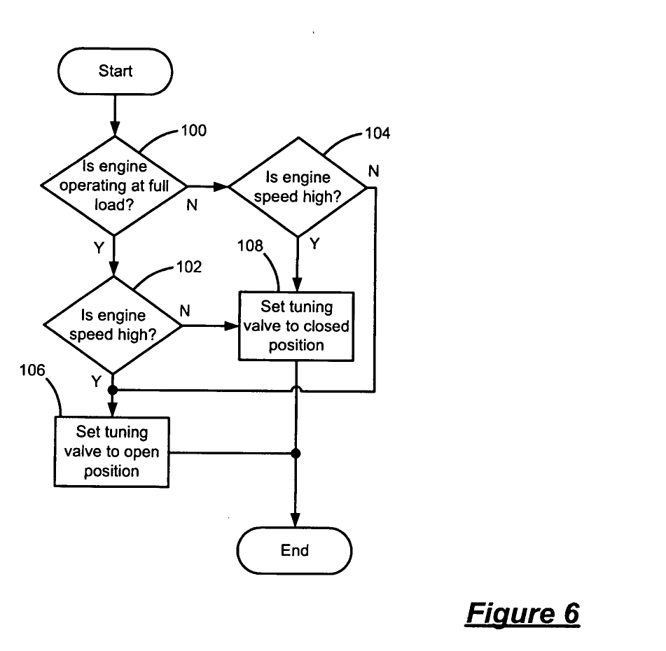

Referring now to FIG. 6, the four operational category engine control of the present invention will be described in detail. In step 100, control determines whether the engine 10 is operating at full load based on the load command. If the engine 10 is operating at full load, control continues in step 102. If the engine 10 is not operating at full load (i.e., the engine 10 is operating at partial load), control continues in step 104.

In step 102, control determines whether the engine speed is high based on N_{THRESH}. If the engine speed is high, control sets the tuning valve 30 to the open position (i.e., intake manifold in detuned state) in step 106 and control ends. If the engine speed is low, control sets the tuning valve 30 to the closed position (i.e., intake manifold in tuned state) in step 108 and control ends.

In step 104, control determines whether the engine speed is high based on N_{THRESH}. If the engine speed is high, control sets the tuning valve 30 to the closed position (i.e., intake manifold in tuned state) in step 108 and control ends. If the engine speed is low, control sets the tuning valve 30 to the open position (i.e., intake manifold in detuned state) in step 106 and control ends.

The present invention reduces the volumetric efficiency of an internal combustion engine by destructively adding the isentropic wave action of the intake manifold under specific operational categories. In other words, the intake manifold is detuned to reduce the volumetric efficiency for a given load under the specific operational categories. As a result, less throttling is required in the detuned state to produce the same engine load as compared to the tuned state. Although both throttling and detuning can provide the same overall volumetric efficiency and engine load, associated pumping loop losses are lower for the detuned state.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. An engine control system that controls operation of an internal combustion engine, comprising:
an intake manifold that is adjustable to a plurality of resonance geometric configurations; and
a controller that monitors engine operation, that classifies engine operation in one of a plurality of operational categories and that adjusts said intake manifold to a resonance geometric configuration associated with said operational category.

2. The engine control system of claim 1 wherein said resonance geometric configurations include a tuned configuration and a detuned configuration.

3. The engine control system of claim 1 wherein each of said operational categories is based on an engine load.

4. The engine control system of claim 3 further comprising a commanded load input that generates a load command, wherein said controller determines whether an engine load is one of a partial load and a full load based on said load command.

5. The engine control system of claim 4 wherein said controller adjusts said intake manifold to a first resonance geometric configuration if said engine load is said partial load and adjusts said intake manifold to a second resonance geometric configuration if said engine load is said full load.

6. The engine control system of claim 3 wherein each of said operational categories is further based on an engine speed.

7. The engine control system of claim 6 further comprising an engine speed sensor that measures said engine speed, wherein said controller compares said engine speed to a threshold engine speed to determine whether said engine speed is one of a high engine speed and a low engine speed.

8. The engine control system of claim 7 wherein said threshold engine speed is an engine speed at which a volumetric efficiency of said engine is constant regardless of said resonance geometric configuration.

9. The engine control system of claim 8 wherein said threshold engine speed is based on engine load.

10. The engine control system of claim 7 wherein said controller adjusts said intake manifold to a first resonance geometric configuration if said engine load is a partial load and said engine speed is less than said threshold engine speed, adjusts said intake manifold to a second resonance geometric configuration if said engine load is said partial load and said engine speed is greater than said threshold engine speed, adjusts said intake manifold to said first resonance geometric configuration if said engine load is a full load and said engine speed is greater than said threshold engine speed and adjusts said intake manifold to said second resonance geometric configuration if said engine load is said full load and said engine speed is less than said threshold engine speed.

11. The engine control system of claim 1 further comprising:
a tuning valve that is movable between an open position to provide a first resonance geometric configuration and a closed position to divide said intake manifold into multiple plenums and to provide a second resonance geometric configuration; and
an actuator that manipulates said tuning valve based on a signal from said controller.

12. A method for controlling an internal combustion engine having an intake manifold that is adjustable to a plurality of acoustic resonance geometric configurations, comprising:
defining a plurality of operational categories for said engine;
defining a resonance geometric configuration associated with each of said operational categories;
classifying engine operation in an operational category of said operational categories; and
adjusting said intake manifold to said resonance geometric configuration defined for said operational category.

13. The method of claim 12 wherein said resonance geometric configurations include a tuned configuration and a detuned configuration.

14. The method of claim 12 wherein each of said operational categories is based on an engine load.

15. The method of claim 14 wherein each of said operational categories is further based on an engine speed.

16. The method of claim 12 wherein said step of adjusting said intake manifold comprises:
moving a tuning valve to an open position to provide a first resonance geometric configuration; and
moving a tuning valve to a closed position to divide said intake manifold into multiple plenums and to provide a second resonance geometric configuration.

17. The method of claim 12 further comprising:
determining whether an engine load is one of a partial load and a full load based on a load command;
adjusting said intake manifold to a first resonance geometric configuration if said engine load is said partial load; and
adjusting said intake manifold to a second resonance geometric configuration if said engine load is said full load.

18. The method of claim 12 further comprising:
measuring a load command;
determining whether an engine load is one of a partial load and a full load based on said load command;
measuring an engine speed;
comparing said engine speed to a threshold engine speed;
adjusting said intake manifold to a first resonance geometric configuration if said engine load is said partial load and said engine speed is less than said threshold engine speed;
adjusting said intake manifold to a second resonance geometric configuration if said engine load is said partial load and said engine speed is greater than said threshold engine speed;
adjusting said intake manifold to said first resonance geometric configuration if said engine load is said full load and said engine speed is greater than said threshold engine speed; and
adjusting said intake manifold to said second resonance geometric configuration if said engine load is said full load and said engine speed is less than said threshold engine speed.

19. The method of claim 18 wherein said threshold engine speed is an engine speed at which a volumetric efficiency of said engine is constant regardless of said resonance geometric configuration.

20. The method of claim 19 wherein said threshold engine speed is based on engine load.

21. An engine control system that controls operation of an internal combustion engine, comprising:
a load input that generates a load command signal;
an intake manifold that is adjustable to a plurality of resonance geometric configurations and that includes:
a tuning valve that is adjustable to provide a first resonance geometric configuration and a second resonance geometric configuration; and
an actuator that manipulates a position of said tuning valve; and
a controller that monitors engine operation, that classifies engine operation in one of a plurality of operational categories and that signals said actuator to adjust said to provide one of said first and second resonance geometric configurations.

22. The engine control system of claim 21 wherein said first and second resonance geometric configurations include a tuned configuration and a detuned configuration.

23. The engine control system of claim 21 wherein each of said operational categories is based on an engine load.

24. The engine control system of claim 23 wherein said controller determines whether said engine load is one of a partial load and a full load based on said load command.

25. The engine control system of claim 24 wherein said controller adjusts said intake manifold to said first resonance geometric configuration if said engine load is said partial load and adjusts said intake manifold to said second resonance geometric configuration if said engine load is said full load.

26. The engine control system of claim 23 wherein each of said operational categories is further based on an engine speed.

27. The engine control system of claim 26 further comprising an engine speed sensor that measures said engine speed, wherein said controller compares said engine speed to a threshold engine speed to determine whether said engine speed is one of a high engine speed and a low engine speed.

28. The engine control system of claim 27 wherein said threshold engine speed is an engine speed at which a volumetric efficiency of said engine is constant regardless of said resonance geometric configuration.

29. The engine control system of claim 28 wherein said threshold engine speed is based on engine load.

30. The engine control system of claim 27 wherein said controller adjusts said intake manifold to said first resonance geometric configuration if said engine load is a partial load and said engine speed is less than said threshold engine speed, adjusts said intake manifold to said second resonance geometric configuration if said engine load is said partial load and said engine speed is greater than said threshold engine speed, adjusts said intake manifold to said first resonance geometric configuration if said engine load is a full load and said engine speed is greater than said threshold engine speed and adjusts said intake manifold to said second resonance geometric configuration if said engine load is said full load and said engine speed is less than said threshold engine speed.

31. The engine control system of claim 21 wherein said tuning valve is a discrete position tuning valve that is movable between an open position to provide said first resonance geometric configuration and a closed position to divide said intake manifold into multiple plenums and to provide said second resonance geometric configuration.
